(19) United States
(12) Patent Application Publication
(10) Pub. No.: US 2025/0311047 A1
(43) Pub. Date: Oct. 2, 2025

(54) RELAY DEVICE, BASE STATION, AND WIRELESS COMMUNICATION SYSTEM

(71) Applicant: Fujitsu Limited, Kawasaki-shi (JP)

(72) Inventors: Takako HORI, Sagamihara (JP); Katsunari UEMURA, Chiba (JP)

(73) Assignee: Fujitsu Limited, Kawasaki-shi (JP)

(21) Appl. No.: 19/237,226

(22) Filed: Jun. 13, 2025

Related U.S. Application Data
(63) Continuation of application No. PCT/JP2023/006888, filed on Feb. 24, 2023.

(51) Int. Cl. H04W 76/27; H04W 28/08

(52) U.S. Cl. CPC H04W 76/27; H04W 28/0835

(57) ABSTRACT

A relay device includes a controller configured to execute a first process when a state of RRC transitions from a first state to a second state; a transmitter configured to transmit a first signal for transitioning the state of the RRC from the second state to a third state according to the first process; and a receiver configured to receive a transmitted second signal in response to the first signal, wherein the controller transitions the state of the RRC from the second state to the third state according to the second signal.

### CROSS-REFERENCE TO RELATED APPLICATION

This application is a continuation application of International Application PCT/JP2023/006888 filed on Feb. 24, 2023 and designated the U.S., the entire contents of which are incorporated herein by reference.

### FIELD

The present embodiment relates to a relay device, a base station, and a wireless communication system.

### BACKGROUND

In current networks, traffic of mobile terminals (smartphones or feature phones) account for a majority network resources. In addition, the traffic used by the mobile terminals tends to expand.

Meanwhile, in addition to the traffic used by the mobile terminals, for example, Internet of Things (IoT) services (for example, a monitoring system of a traffic system, a smart meter, a device, or the like) are being deployed. Therefore, networks are demanded to cope with services having various requirements. In order to cope with such various services, in communication standards (for example, Non Patent Documents 1, 2, and 13 to 28) of the fifth generation of mobile communication (5G or new radio (NR)), for example, in addition to the standard technology (for example, Non Patent Documents 3 to 12) of the fourth generation mobile communication (4G), standards have been developed assuming support of many use cases classified into enhanced mobile broadband (eMBB), massive machine type communications (MTC), and ultra-reliable and low latency communication (URLLC).

In the 5G communication standards, two types of radio bearers of a signaling radio bearer (SRB) and a data radio bearer (DRB) are established to perform communication. The signaling radio bearer (SRB) is a bearer mainly used to transmit and receive a signal of a radio resource control (RRC) message. In addition, there are a plurality of types of signaling radio bearers, and for example, there are an SRB0 used when an RRC message using a common control channel (CCCH) is transmitted, an SRB1 used for transmitting an RRC message using a dedicated control channel (DCCH), and the like. Note that the SRB1 is, for example, set to the terminal according to the configuration information of the SRB1 included in the RRC setup message via the SRB0 .

In addition, a plurality of data radio bearers can be set in the data radio bearer. In addition, a packet data convergence protocol (PDCP) entity, a radio link control (RLC) entity, and a logical channel can be configured for each of the plurality of data radio bearers.

The working group of 3GPP (registered trademark) aims to expand the coverage range. Therefore, in the working group of 3GPP, a network controlled (NC) repeater is mentioned as Work Item of Release 18 (Non Patent Document 29).

The NC repeater has a function of relaying communication between the base station and the terminal, and has, for example, a function of amplifying a signal transmitted from the base station and transmitting the signal to the terminal. It has also been agreed that the NC repeater will support RRC idle and RRC connected and support optional RRC inactive (Non Patent Document 30). It has also been agreed that the RRC-re-establishment procedure will be started when the NC repeater detects a radio link failure (Non Patent Document 30).

For example, related arts are disclosed in 3GPP TS 23.502 V17.7.0 (Non Patent Document 1), 3GPP TS 24.501 V17.9.0 (Non Patent Document 2), 3GPP TS 36.133 V17.8.0 (Non Patent Document 3), 3GPP TS 36.211 V17.2.0 (Non Patent Document 4), 3GPP TS 36.212 V17.1.0 (Non Patent Document 5), 3GPP TS 36.213 V17.4.0 (Non Patent Document 6), 3GPP TS 36.214 V17.0.0 (Non Patent Document 7), 3GPP TS 36.300 V17.3.0 (Non Patent Document 8), 3GPP TS 36.321 V17.3.0 (Non Patent Document 9), 3GPP TS 36.322 V17.0.0 (Non Patent Document 10), 3GPP TS 36.323 V17.2.0 (Non Patent Document 11), 3GPP TS 36.331 V17.3.0 (Non Patent Document 12), 3GPP TS 37.324 V17.0.0 (Non Patent Document 13), 3GPP TS 37.340 V17.3.0 (Non Patent Document 14), 3GPP TS 38.304 V17.3.0 (Non Patent Document 15), 3GPP TS 38.133 V17.8.0 (Non Patent Document 16), 3GPP TS 38.201 V17.0.0 (Non Patent Document 17), 3GPP TS 38.202 V17.3.0 (Non Patent Document 18), 3GPP TS 38.211 V17.4.0 (Non Patent Document 19), 3GPP TS 38.212 V17.4.0 (Non Patent Document 20), 3GPP TS 38.213 V17.4.0 (Non Patent Document 21), 3GPP TS 38.214 V17.4.0 (Non Patent Document 22), 3GPP TS 38.215 V17.2.0 (Non Patent Document 23), 3GPP TS 38.300 V17.3.0 (Non Patent Document 24), 3GPP TS 38.321 V17.3.0 (Non Patent Document 25), 3GPP TS 38.322 V17.2.0 (Non Patent Document 26), 3GPP TS 38.323 V17.3.0 (Non Patent Document 27), 3GPP TS 38.331 V17.3.0 (Non Patent Document 28), RP-222673 (Non Patent Document 29), and R2-2213009 (Non Patent Document 30).

### SUMMARY

According to an aspect of the embodiments, a relay device including: a controller configured to execute a first process when a state of RRC transitions from a first state to a second state; a transmitter configured to transmit a first signal for transitioning the state of the RRC from the second state to a third state according to the first process; and a receiver configured to receive a transmitted second signal in response to the first signal. The controller transitions the state of the RRC from the second state to the third state according to the second signal.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is a diagram illustrating an example of a wireless communication system according to a first embodiment;

FIG. 2 is a diagram illustrating an example of a functional configuration diagram of a base station;

FIG. 3 is a diagram illustrating an example of a functional configuration diagram of a relay device;

FIG. 4 is a diagram illustrating an example of a functional configuration diagram of a terminal;

FIG. 5 is a diagram illustrating an example of a configuration of an NCR;

FIG. 6 is a diagram illustrating an example of a process sequence of the wireless communication system in the first embodiment;

FIG. 7 is a diagram illustrating an example of process in the relay device according to the first embodiment;

FIG. 8 is a diagram illustrating an example of a layer configuration of the relay device;

FIG. 9 is a diagram illustrating an example of process in a relay device of a second embodiment;

FIG. 10 is a diagram illustrating an example in which a first example of a first process of the NCR in the RRC inactive state according to a third embodiment is reflected in the specification (TS38.331);

FIG. 11 is a diagram illustrating an example in which a second example of the first process of the NCR in the RRC inactive state according to the third embodiment is reflected in the specification (TS24.501);

FIG. 12 is an example of a hardware configuration diagram of the base station in the wireless communication system;

FIG. 13 is an example of a hardware configuration diagram of the relay device in the wireless communication system; and

FIG. 14 is an example of a hardware configuration diagram of the terminal in the wireless communication system.

### DESCRIPTION OF EMBODIMENT(S)

For example, in a case where the connection destination cell is not found in the RRC-re-establishment procedure, the NC repeater may autonomously transition to the RRC IDLE state. Then, the NC repeater needs to wait until the transition timing of RRC CONNECTED.

For example, in the case of the terminal device, it is possible to transition from RRC_IDLE to RRC_CONNECTED when user data is occurred, but in the NC repeater, the possibility that data is occurred is significantly reduced. Furthermore, for example, it is conceivable to transition from RRC_IDLE to RRC_CONNECTED at the timing of the periodical registration procedure, but this cycle is set to be long time (for example, with a default value, 1 hour).

Therefore, for example, there is a possibility that the relay device enters the state of RRC_IDLE at a timing when the base station transmits a signal to the terminal via the relay device. Therefore, there is a possibility that the relay device fails to appropriately process the signal transmitted from the base station to the terminal.

For example, when the relay device is in the state of RRC_IDLE at a timing at which the base station transmits a signal to the terminal via the relay device, a method for transitioning an RRC state from RRC_IDLE to the state of RRC_CONNECTED is needed, but there is no specific method at present. Note that, although the NC repeater has been described as an example, the same applies to a similar relay device or communication device such as an integrated access backhole (IAB) other than the NC repeater.

Hereinafter, the present embodiment will be described in detail with reference to the drawings. Problems and embodiments in the present specification are merely examples, and do not limit the scope of rights of the present application. In particular, the technology of the present application can be applied to even different expressions as long as the expressions are technically equivalent even if the expressions are different, and the scope of rights is not limited. Each embodiment can be appropriately combined within a range in which the process contents do not contradict each other.

In addition, terms and technical contents described in the present specification may be appropriately used as terms and technical contents described in a specification or a contribution as a communication standard such as 3GPP. Such specifications are described in Non Patent Documents 1 to 30, for example.

Hereinafter, embodiments of a base station, a relay device, a terminal, and a wireless communication system disclosed in the present application will be described in detail with reference to the drawings. Note that the following embodiments do not limit the disclosed technology.

### First Embodiment

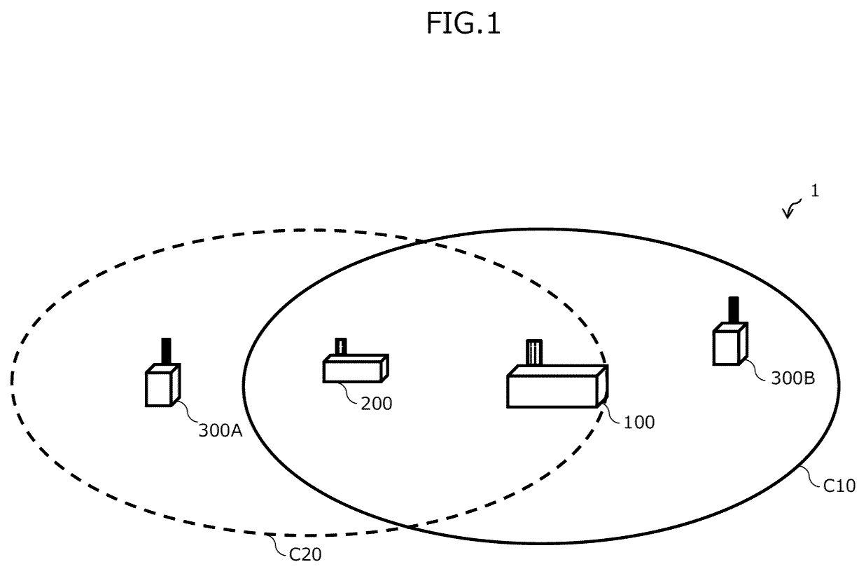

FIG. 1 is a diagram illustrating an example of a wireless communication system 1 according to a first embodiment. The wireless communication system 1 includes a base station 100, a relay device 200, and terminals 300A and 300B. Note that the base station 100 forms a cell C10. The relay device 200 forms a cell C20. The terminal 300A does not exist in cell C10, but exists in cell C20. In addition, the terminal 300B exists in the cell C10. Note that the terminals 300A and 300B will be simply referred to as a terminal 300 in a case where they are not distinguished from each other. Note that the relay device 200 and the terminal 300 may be collectively referred to as a communication device.

Note that the base station 100 may be, for example, a small radio base station (including a micro radio base station, a femto radio base station, and the like) such as a macro radio base station, a pico radio base station, and other wireless base stations of various scales, and may be described in terms of a wireless communication device, a communication device, a transmission device, and the like. Furthermore, the relay device 200 may be a communication device having various functions and having a function of relaying a signal, and may be referred to as a wireless communication device, a communication device, a reception device, a repeater, or the like. Furthermore, the terminal 300 may be, for example, various devices having a wireless communication function, such as a mobile phone, a smartphone, a personal digital assistant (PDA), a personal computer, a vehicle, an airplane, and a drone, or a wireless terminal of a device (a sensor device or the like) mounted on a robot, an AV device, a household appliance, an office appliance, a vending machine, other household appliances, an industrial device, or the like, and may be referred to as a wireless communication device, a communication device, a reception device, a mobile station, or the like.

The base station 100 is connected to a network via a wired connection with a network device (an upper-level device or another base station) (not illustrated). Note that the base station 100 may be connected to the network device wirelessly instead of the wired manner.

The base station 100 may separate the wireless communication function with the terminal 300 from the digital signal processing and control function to form a separate device. In this case, a device having a wireless communication function can be referred to as a remote radio head (RRH), and a device having a digital signal processing and control function can be referred to as a base band unit (BBU). In addition, the RRHs may be installed to protrude from the BBU, and each of the RRHs and the BBU may be connected to each other in a wired manner with an optical fiber or the like. Alternatively, they may be connected in a wireless manner. Further, for example, the base station 100 may be separated into a central unit (CU), a distributed unit (DU), and a radio unit (RU) instead of the RRHs and the BBUs described above. The DU includes, for example, a function of a media access control (MAC) layer. In addition, the DU may include, for example, a function of a radio link control (RLC) layer. The RU includes at least an RF radio circuit. The DU and the RU may be integrated.

On the other hand, the terminal 300 communicates with the base station 100 by wireless communication. Note that the terminal 300A communicates with the base station 100 via the relay device 200. Further, when receiving the signal transmitted from the base station 100, the relay device 200 amplifies the received signal and transmits the amplified signal. For example, the relay device 200 receives a signal directed to the terminal 300A from the base station 100, amplifies the received signal, and transmits the amplified signal toward the terminal 300A.

When the RRC connection is not established with the relay device 200, the base station 100 performs a process for establishing the RRC connection. Furthermore, when the RRC connection is not established with the terminal 300, the base station 100 performs process for establishing the RRC connection.

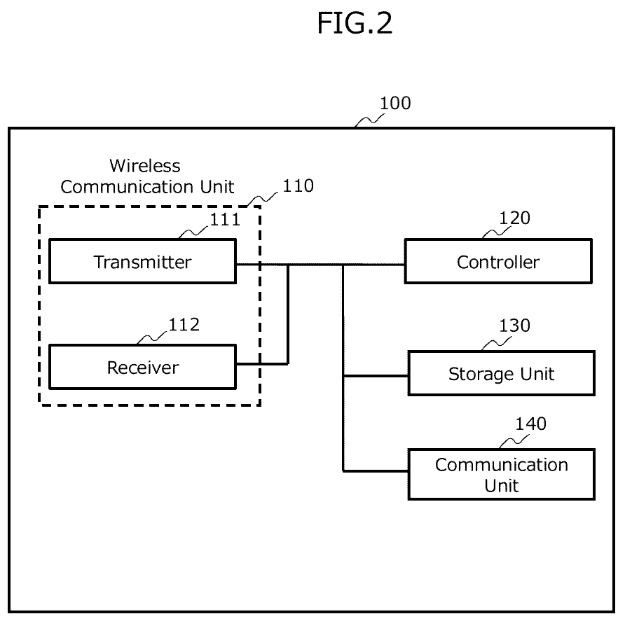

Next, the base station 100 will be described. FIG. 2 is a diagram illustrating an example of a functional configuration diagram of the base station 100. The base station 100 includes a wireless communication unit 110, a controller 120, a storage unit 130, and a communication unit 140.

The wireless communication unit 110 includes a transmitter 111 and a receiver 112, and performs wireless communication with the terminal 300. Specifically, the transmitter 111 transmits, for example, a downlink signal such as a signal of a random access procedure, a signal of an RRC layer, a downlink data signal, and a downlink control signal to the terminal 300. In addition, the transmitter 111 transmits, for example, a downlink signal such as a signal of a random access procedure or a signal of an RRC layer to the relay device 200.

Furthermore, the receiver 112 can receive, for example, an uplink signal such as a signal of a random access procedure, a signal of an RRC layer, an uplink data signal, and an uplink control signal transmitted from the terminal 300. Note that the receiver 112 may receive the amplified various signals after the various signals transmitted from the terminal 300 are amplified by the relay device. Furthermore, the receiver 112 can receive, for example, an uplink signal such as a signal of a random access procedure, a signal of an RRC layer, and an uplink control signal transmitted from the relay device 200.

The controller 120 controls the base station 100. Specifically, the controller 120 can control establishment of an RRC connection with the relay device 200, establishment of an RRC connection with the terminal 300, signal processing of a signal received by the receiver 112, creation of a transport block (TB), mapping of the transport block to a radio resource, and the like.

The storage unit 130 can store, for example, a downlink data signal.

The communication unit 140 is connected to a network device (for example, an upper-level device or another base station device) in a wired or wireless manner to perform communication. The data signal directed to the terminal 300 received by the communication unit 140 can be stored in the storage unit 130.

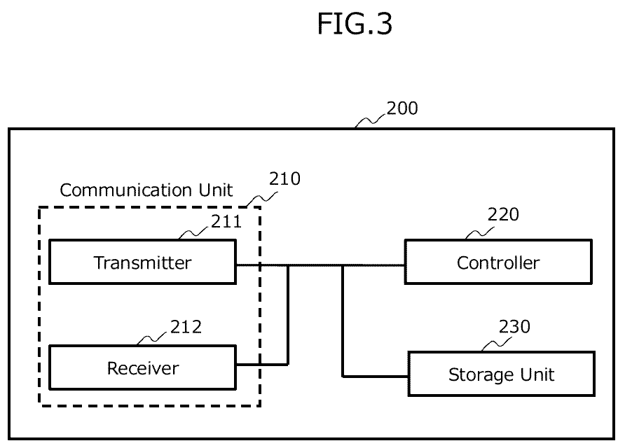

Next, the relay device 200 will be described. FIG. 3 is a diagram illustrating an example of a functional configuration diagram of the relay device 200. As illustrated in FIG. 3, the relay device 200 includes a communication unit 210, a controller 220, and a storage unit 230. These components are connected so that signals and data can be input and output in one direction or in both directions. Note that the communication unit 210 can be described separately as a transmitter 211 and a receiver 212.

The transmitter 211 transmits, for example, an uplink signal such as an RRC layer signal or an uplink control signal to the base station via an antenna. In addition, for example, in a case where a signal directed to the base station 100 transmitted from the terminal 300 is received, the transmitter 211 amplifies the received signal and transmits the amplified signal. Furthermore, for example, in a case where a signal directed to the terminal 300 transmitted from the base station 100 is received, the transmitter 211 amplifies the received signal and transmits the amplified signal.

The receiver 212 receives, for example, a downlink signal such as an RRC layer signal or a downlink control signal transmitted from the base station 100. Further, for example, when receiving a signal directed to the base station 100 transmitted from the terminal 300, the receiver 212 transmits the received signal to the transmitter 211. Further, for example, when receiving a signal directed to the terminal 300 transmitted from the base station 100, the receiver 212 transmits the received signal to the transmitter 211.

The controller 220 controls the relay device 200. Specifically, the controller 220 can control establishment of an RRC connection with the base station 100, signal processing of a signal received by the receiver 212, creation of a transport block (TB), mapping of the transport block to a radio resource, and the like. In addition, the controller 220 controls the RRC state in the relay device 200. For example, the controller 220 controls at least one of a transition from RRC_IDLE to RRC_CONNECTED, a transition from RRC_CONNECTED to RRC_IDLE, a transition from RRC CONNECTED to RRC_INACTIVE, a transition from RRC_INACTIVE to RRC_CONNECTED, and a transition from RRC_IDLE to RRC_CONNECTED as the RRC state of the relay device 200.

The storage unit 230 can store, for example, configuration information (or setting information) of the RRC related to the wireless communication transmitted from the base station 100.

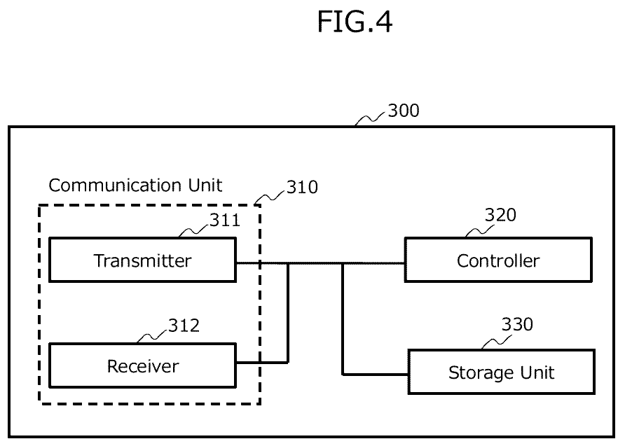

Next, the terminal 300 will be described. FIG. 4 is a diagram illustrating an example of a functional configuration diagram of the terminal 300. As illustrated in FIG. 4, the terminal 300 includes a communication unit 310, a controller 320, and a storage unit 330. These components are connected so that signals and data can be input and output in one direction or in both directions. Note that the communication unit 310 can be described separately as a transmitter 311 and a receiver 312.

The transmitter 311 transmits a data signal and a control signal by wireless communication via an antenna. Note that the antenna may be common for transmission and reception. The transmitter 311 transmits, for example, an uplink signal such as a signal of a random access procedure, a signal of an RRC layer, an uplink data signal, and an uplink control signal.

The receiver 312 receives a downlink signal such as a signal of a random access procedure, a downlink data signal, and a downlink control signal transmitted from the base station 100, for example. Furthermore, the received signal may include, for example, a reference signal used for channel estimation and demodulation. In addition, the receiver 312 may receive the amplified various signals after the various signals transmitted from the base station 100 are amplified by the relay device.

The controller 320 controls the terminal 300. Specifically, the controller 320 can control establishment of an RRC connection with the base station 100, signal processing of a signal received by the receiver 312, creation of a transport block (TB), mapping of the transport block to a radio resource, and the like.

The storage unit 330 can store, for example, an uplink data signal. In addition, the storage unit 330 can store configuration information (or setting information) related to wireless communication transmitted from the base station 100.

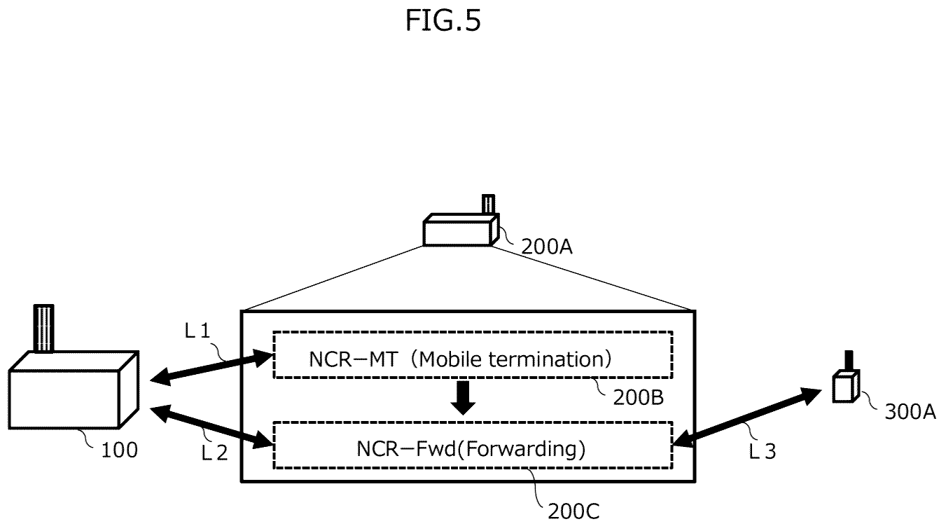

Next, an NC repeater (hereinafter, it may be referred to as NCR) which is an example of the relay device 200 will be described. FIG. 5 is a diagram illustrating an example of a configuration of the NCR. As illustrated in FIG. 5, a NCR 200A includes a NCR-mobile termination (NCR-MT) 200B and a NCR-forwarding (NCR-Fwd) 200C. For example, the NCR-Fwd 200C amplifies a signal received from the base station 100, the terminal 300, or the like, and transmits the amplified signal to the transmission destination, for example, the base station 100, the terminal 300, or the like. Further, the NCR-MT 200B can control the operation of the NCR-Fwd 200C according to control information received from the base station 100, for example. For example, the NCR-MT 200B can perform gain adjustment performed by the NCR-Fwd 200C, setting of a transmission timing of a signal to be relayed, and the like. Note that the control information received by the NCR-MT 200B is included in, for example, any of a signal of the RRC layer, a signal of the MAC layer, and a signal of the physical layer and transmitted. The control information includes, for example, power adjustment information. In addition, the NCR-MT 200B can control the transition of the RRC state of the NCR 200A.

Note that the control information is transmitted from the base station 100 to the NCR-MT 200B via a control link L1 between the NCR-MT 200B and the base station 100, for example. In addition, the NCR-Fwd 200C receives a signal from the base station 100 via an access link L2, for example. Further, the NCR-Fwd 200C transmits a signal to the terminal 300A via an access link L3, for example.

By the functions of the NCR-MT 200B and the NCR-Fwd 200C, the NCR 200A can perform an amplification control operation of a signal to be relayed according to the control information from the base station 100.

Note that the NCR-MT 200B and the NCR-Fwd 200C are distinguished from each other in terms of the function of the NCR 200A, but are integrated as a communication device and have the functional configuration illustrated in FIG. 3. For example, the process related to the transmission performed by the NCR-MT 200B and the NCR-Fwd 200C is performed by the transmitter 211. Further, for example, the process related to the reception performed by the NCR-MT 200B and the NCR-Fwd 200C is performed by the receiver 212. Further, for example, the process related to the control performed by the NCR-MT 200B and the NCR-Fwd 200C is performed by the controller 220.

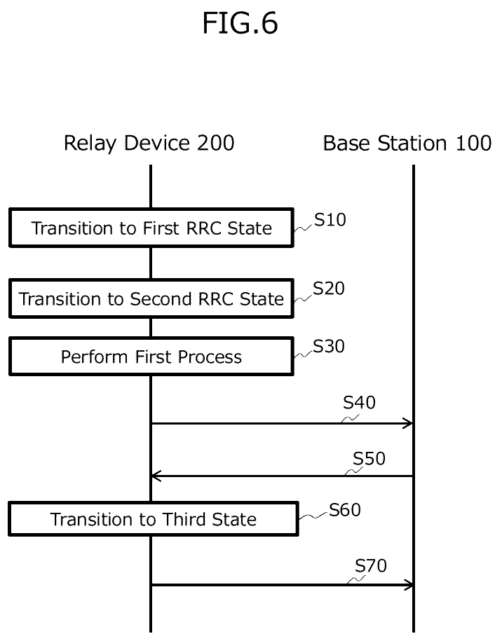

Next, an example of a process sequence in the wireless communication system 1 will be described with reference to FIG. 6. FIG. 6 is a diagram illustrating an example of the process sequence of the wireless communication system in the first embodiment.

The controller 220 of the relay device 200 transitions the RRC state to a first state (step S10). The first state is, for example, RRC connected (RRC_CONNECTED) or RRC inactive (RRC_INACTIVE).

The controller 220 of the relay device 200 transitions the RRC state to a second state different from the first state (step S20). The second state is, for example, RRC idle (RRC_IDLE).

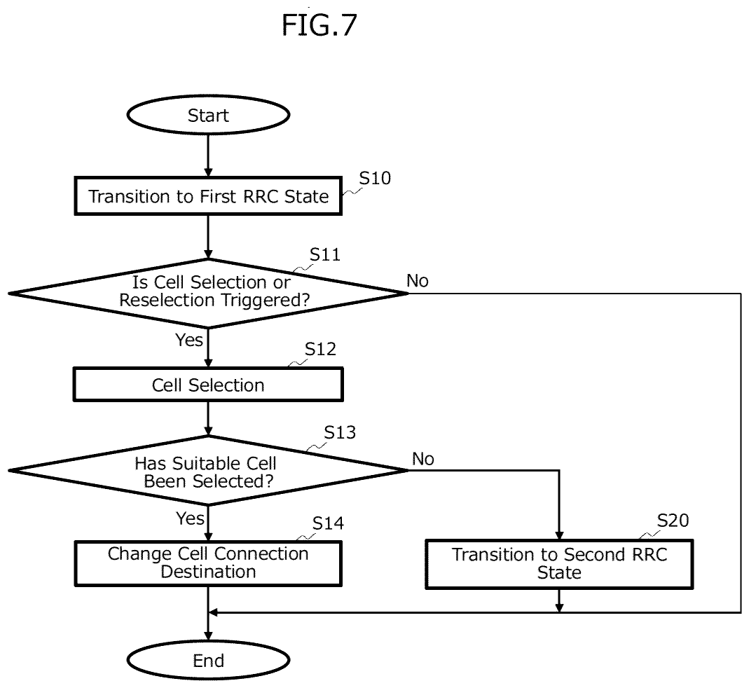

Here, a process of transitioning the state of the RRC from the first state to the second state in the relay device 200 will be described. FIG. 7 is a diagram illustrating an example of process in the relay device 200 according to the first embodiment. Note that FIG. 7 is a diagram for explaining a change of a cell or a transition of an RRC state according to cell selection or reselection.

After the state of the RRC transitions to the first state (step S10), the controller 220 of the relay device 200 determines whether or not cell selection or reselection is triggered (step S11).

When cell selection or reselection is not triggered (step S11: No), the controller 220 of the relay device 200 ends the process. When cell selection or reselection is triggered (step S11: Yes), the controller 220 of the relay device 200 executes cell selection (step S12). Note that the cell selection is performed, for example, by measuring reference signals received from one or more cells and performing the cell selection according to a measurement result. For example, in the cell selection, a cell in which the reception power of the reference signal received from one or more cells is a given (predetermined) value or more is selected. Further, for example, in the cell selection, when there are a plurality of cells whose reception power is a measurement result of a given (predetermined) value or more, a cell having the largest reception power is selected from the plurality of cells. Further, for example, in the cell selection, a cell satisfying a certain condition including the above condition among cells belonging to a selected or registered public land mobile network (PLMN) or equivalent PLMN list is selected as a suitable cell. Further, for example, in the cell selection, when it is not possible to select a suitable cell, a cell that satisfies a certain condition including the above condition but does not belong to the selected or registered PLMN or the equivalent PLMN list is selected as an acceptable cell.

When it is not possible to select a suitable cell in step S13 (step S13: No), the controller 220 of the relay device 200 transitions the RRC state from the first state to the second state (step S20). Note that the “transition to the second RRC state” in step S20 may be paraphrased as “when acceptable cell is selected, change the cell connection destination to the selected acceptable cell and transition to the second RRC state”.

When a suitable cell has been selected in step S13 (step S13: Yes), the controller 220 of the relay device 200 performs process of changing the cell connection destination to the selected suitable cell (step S14).

Through the above process, the relay device 200 controls the change of the cell or the transition of the RRC state accompanying the cell selection or the reselection. Note that FIG. 6 corresponds to a sequence diagram when no cell is selected in step S13 and the state transitions to the second state in FIG. 7. Therefore, step S20 in FIG. 6 and step S20 in FIG. 7 are the same process.

The description returns to FIG. 6. When the RRC state transitions to the second state, the controller 220 of the relay device 200 performs a first process (step S30). For example, the first process is a process of triggering a second process. The second process is, for example, a process for updating the registration area. Note that the second process may include that the transmitter 211 of the relay device 200 transmits a fourth signal. The fourth signal is, for example, a registration request message (REGISTRATION REQUEST message) which is a signal of NAS.

The transmitter 211 of the relay device 200 transmits a first signal to the base station 100 after the first process (step S40). Note that the first signal is, for example, a signal of an RRC layer. The first signal is, for example, an RRC setup request message. Note that the first signal is, for example, a signal to be transmitted according to the first process performed by the transition of the RRC state to the second state, and thus can be rephrased as a first signal to be transmitted according to the transition to the second RRC state.

When the receiver 112 receives the first signal (step S40), the controller 120 of the base station 100 performs process according to the first signal. Note that the process according to the first signal is, for example, generation of RRC configuration information for the relay device 200.

The transmitter 120 of the base station 100 transmits a second signal corresponding to the first signal (step S50). Note that the second signal is, for example, an RRC layer signal including RRC configuration information configured according to the first signal. The second signal is, for example, an RRC setup message.

When the receiver 212 receives the second signal (step S50), the controller 220 of the relay device 200 transitions the RRC state from the second state to a third state (step S60). Note that the third state is an RRC state different from the second state.

Then, the transmitter 211 of the relay device 200 transmits a third signal to the base station 100 (step S70). Note that the third signal is, for example, a signal of the RRC layer. The third signal is, for example, an RRC setup complete message.

As described above, in the first embodiment, when the state of the RRC of the relay device 200 transitions to the second state, the state of the RRC can be changed by executing the first process. In other words, it is possible to control the transition of the RRC state of the communication device such as the relay device 200. For example, in a case where the second state is the RRC idle state, since the first process for transitioning to a state different from the idle state is executed at the timing of transitioning to the idle state, when the base station 100 transmits a signal to the terminal 300, the probability that the RRC state of the relay device 200 is the idle state can be reduced.

Note that the relay device 200 described in the first embodiment may be adapted to a communication device having a similar function. For example, when the terminal 300 has a relay function and relays communication between another terminal 300 and the base station 100, the transition of the RRC state may be controlled using the method of the first embodiment. In this case, the controller 320 of the terminal 300 having a relay function determines whether or not to perform the first process described as the process of the relay device 200 or the second process which is the process of the normal terminal 300 according to whether or not the local terminal relays another terminal 300.

### Second Embodiment

In the first embodiment, an example has been described in which the first signal is transmitted in response to the transition of the relay device 200 to the second RRC state, and the state of the RRC transitions from the second state to the first state. In the second embodiment, a more specific method of the first embodiment will be described. In the second embodiment, the wireless communication system, the base station, the relay device, and the terminal are the same as those in the first embodiment, and thus the description thereof will be omitted. In the second embodiment, the second state is described as RRC idle, and the third state is described as RRC connected.

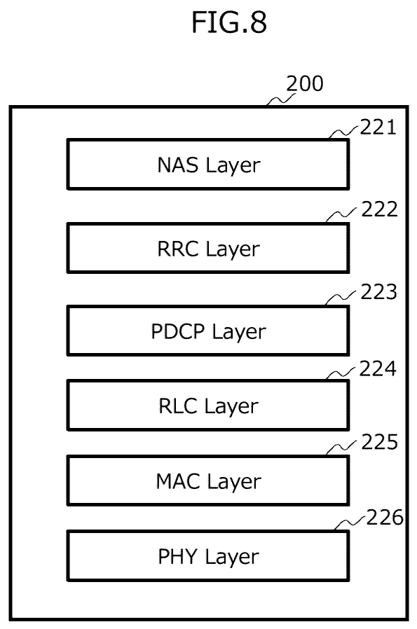

A configuration of each layer of the relay device 200 will be described with reference to FIG. 8. FIG. 8 is a diagram illustrating an example of a layer configuration of the relay device 200. The relay device 200 includes a NAS layer 221, an RRC layer 222, a packet data convergence protocol (PDCP) layer 223, a radio link control (RLC) layer 224, a medium access control (MAC) layer 225, and a physical (PHY) layer 226. For example, the NAS layer 221, the RRC layer 222, the PDCP layer 223, the RLC layer 224, and the MAC layer 225 may perform the process of the NCR-MT 200B, and the PHY layer 226 may perform the process of the NCR-MT 200B and the NCR-Fwd 200C. Therefore, a plurality of PHY layers 226 may be provided. Furthermore, one communication device may be formed by one or a plurality of layers, and the relay device 200 may be formed by a plurality of communication devices.

Note that, in FIG. 8, for example, the closer to the NAS layer 221, the higher the layer. Furthermore, for example, the closer to the PHY layer, the lower the layer. Therefore, for example, the NAS layer 221 can be described as an upper layer of the RRC layer 222. Similarly, the RRC layer 222 can be described as a lower layer of the NAS layer 221.

The NAS layer 221 is, for example, a layer that executes process of a NAS signal related to the NAS layer 221. The NAS layer 221 is, for example, a layer that executes at least a part of the first process. In addition, the NAS layer 221 terminates the protocol with, for example, the NAS layer 221 provided in an access and mobility management function (AMF) included in an upper-level device of the core network. The RRC layer 222 is, for example, a layer that executes process of an RRC signal related to the RRC layer 222 and controls a state of the RRC. The PDCP layer 223 is, for example, a layer that performs process of a PDCP signal related to the PDCP layer 223. The RLC layer 224 is, for example, a layer that executes process of a NAS signal related to the RLC layer 224. The MAC layer 225 is, for example, a layer that executes process of a MAC signal related to the MAC layer 225. The PHY layer 226 is, for example, a layer that executes process of a signal related to the PHY layer 226. Furthermore, for example, the RRC layer 222, the PDCP layer 223, the RLC layer 224, the MAC layer 225, and the PHY layer 226 terminate protocols respectively with the RRC layer 222, the PDCP layer 223, the RLC layer 224, the MAC layer 225, and the PHY layer 226 included in the base station 100. Note that the process of the various layers is performed by the controller 220. Note that the controller 220 different for each layer may be configured.

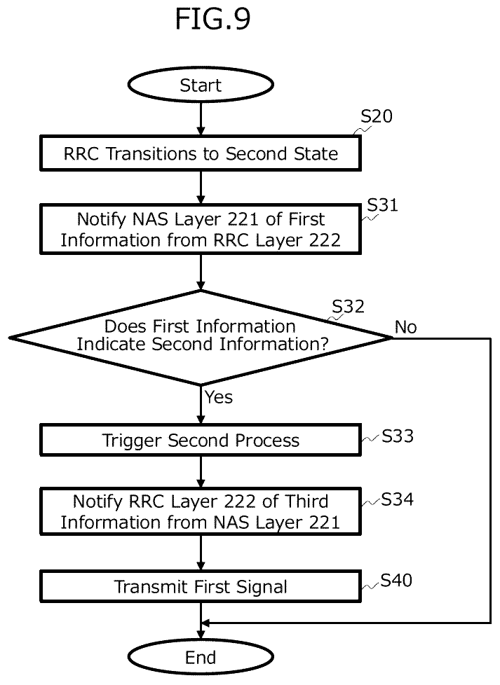

An example of process of the relay device 200 in the second embodiment will be described with reference to FIG. 9. FIG. 9 is a diagram illustrating an example of process in the relay device 200 according to the second embodiment. Note that parts that perform the same process as in FIG. 6 are denoted by the same reference numerals, and description thereof is omitted. In FIG. 9, the first process is described as a registration area update process, but the second embodiment is not limited thereto.

When transitioning the RRC state to the second state (step S20), the RRC layer 222 of the relay device 200 notifies the NAS layer 221 of the first information (step S31). The first information is, for example, information on a cause indicating that the state of the RRC becomes the idle state. The first information can be described as, for example, a release cause. In other words, in step S31, the RRC layer 222 notifies the upper layer of the first information.

The NAS layer 221 of the relay device 200 determines whether or not the first information indicates the second information (step S32). Note that the second information corresponds to, for example, at least one piece of information among a plurality of pieces of information that is a cause indicating that the RRC state has become the idle state. For example, in a case where there are three types of information that cause the state of the RRC to become the idle state, at least one of the three types corresponds to the information.

For example, in a case where there are three types (Type 1, Type 2, and Type 3) of information that cause the state of the RRC to become the idle state, the second information corresponds to type 1. In addition, in a case where there are three types (Type 1, Type 2, and Type 3) of information that cause the state of the RRC to become the idle state, the second information may be set to a plurality of types so as to correspond to type 1 and type 2.

When the first information is information indicating the second information (step S32: Yes), the NAS layer 221 of the relay device 200 triggers the second process (step S33). Note that triggering the second process can also mean, for example, starting an operation of controlling the relay device 200 so that the fourth signal can be transmitted. The second process is, for example, a registration area update process.

In a case where the first information is not the information indicating the second information (Step S32: No), the NAS layer 221 of the relay device 200 ends the process.

Note that, when the second process is triggered, the relay device 200 needs to transition to the RRC connected in order to transmit the fourth signal. Therefore, the NAS layer 221 notifies the RRC layer 222 of the third information related to the update of the RRC state (step S34). Note that the third information is, for example, information for requesting a change in the state of the RRC. Note that step S33 and step S34 may be combined into one process, and in a case where the first information is information indicating the second information (step S32: Yes), the NAS layer 221 may notify the RRC layer 222 of the third information related to the update of the RRC state. In addition, in step S33, it may be described that the NAS layer 221 notifies the lower layer of the third information related to the update of the RRC state. Note that steps S31 to S34 in FIG. 9 are an example of the first process.

Then, the RRC layer 222 of the relay device 200 transmits the first signal via the transmitter 211 (step S40). The first signal may be described as a signal to be transmitted according to the third information, or may be described as a signal to be transmitted when the first process is completed. Furthermore, the first signal may be described as a signal to be transmitted in response to the notification from the NAS layer 221 to the RRC layer 222.

Note that the second process is performed after the transition to the third state. Therefore, the fourth signal is performed after the transmission of the third signal. Alternatively, the third signal may be multiplexed with the fourth signal and transmitted together. When the third signal and the fourth signal are collectively transmitted, for example, the signals of the NAS layer 221 can be multiplexed by piggybacking the signals of the RRC layer 222.

Here, the second process will be described. The second process can be rephrased as a process related to the NAS layer.

The NAS layer 221 of the relay device 200 performs control to transmit a fourth signal which is a signal of the NAS layer after the state of the RRC transitions to the RRC connected state. As described above, the fourth signal may be piggy-backed on the third signal, multiplexed with the third signal, and transmitted. Note that the fourth signal is transmitted to a device having a function of an access and mobility management function (AMF) included in the upper-level device via the base station 100, for example.

The NAS layer 221 of the relay device 200 receives, via the receiver 212, a fifth signal that is a signal of the NAS layer and is transmitted in response to the fourth signal. The fifth signal is, for example, a registration accept message (REGISTRATION ACCEPT message). Note that the registration accept message is transmitted using, for example, DLInformation Transfer which is a signal of the RRC layer 222.

Then, the NAS layer 221 of the relay device 200 transmits a sixth signal of the NAS layer via the transmitter 211. The sixth signal is, for example, a registration completion message (REGISTRATION COMPLETE message). Note that the registration completion message is transmitted using, for example, ULInformationTransfer, which is a signal of the RRC layer 222.

As described above, in the second embodiment, the relay device 200 that has transitioned to the RRC idle state can start the first process for entering the RRC connected state at the transition timing. Therefore, when the state of the RRC of the relay device 200 transitions to the second state, the state of the RRC can be changed by executing the first process. In short, when the state of the RRC of the relay device 200 transitions to the second state, the state of the RRC can be changed by executing the first process. In other words, it is possible to control the transition of the RRC state of the communication device such as the relay device 200. For example, since the relay device 200 in the RRC idle state executes the first process for transitioning to a state different from the idle state at the timing of transitioning to the idle state, when the base station 100 transmits a signal to the terminal 300, it is possible to reduce the probability that the RRC state of the relay device 200 is the idle state.

Note that the relay device 200 described in the second embodiment may be adapted to a communication device having a similar function. For example, when the terminal 300 has a relay function and relays communication between another terminal 300 and the base station 100, the transition of the RRC state may be controlled using the method of the second embodiment. In this case, the controller 320 of the terminal 300 having a relay function determines whether or not to perform the first process described as the process of the relay device 200 or the second process which is the process of the normal terminal 300 according to whether or not the local terminal relays another terminal 300.

### THIRD EMBODIMENT

In the first embodiment, an example has been described in which the first signal is transmitted in response to the transition of the relay device 200 to the second RRC state, and the state of the RRC transitions from the second state to the third state. In the second embodiment, a more specific method of the first embodiment has been described. A third embodiment describes a detailed example of a relationship between first information and second information in the second embodiment. In the third embodiment, the wireless communication system, the base station, the relay device, and the terminal are the same as those in the first embodiment and the second embodiment, and thus the description thereof is omitted. In the third embodiment, the first state is described as RRC inactive or RRC connected, the second state is described as RRC idle, and the third state is described as RRC connected.

In the third embodiment, the relay device 200 is described as the NCR 200A, but the third embodiment is not limited thereto.

First, the release cause for the terminal 300 defined in the current specification will be described.

Currently, there are “RRC Resume failure”, “RRC Connection failure”, and “Other” as release causes defined in the specification. These are release causes for the terminal 300. When receiving the “RRC Resume failure” and the “RRC Connection failure” from the RRC layer, the NAS layer of the terminal 300 executes, for example, a registration area update process. Note that the “RRC Resume failure” is an example of a first cause. The “RRC Connection failure” is an example of a second cause. In addition, “Other” is an example of a third cause.

When the terminal 300 in the RRC inactive transitions from RRC inactive to RRC idle, the NAS layer of the terminal 300 is notified of “Other” as the release cause from the RRC layer of the terminal 300. In that case, the corresponding process is not defined in the NAS layer of the terminal 300. In other words, the terminal 300 maintains the state of the RRC layer in the RRC idle state. In the case of the terminal 300, since it is possible to transition from RRC idle to RRC connected when data addressed to the local terminal or data transmitted from the local terminal is occurred, even if the state of the RRC layer is maintained, the influence is small. In addition, even if the influence occurs, only the local terminal is affected.

Hereinafter, the relationship between the first information and the second information in the third embodiment in consideration of the impact on the specification will be described with reference to the process of the release cause on the terminal 300.

As the control of the RRC connected NCR 200A, the second information is, for example, “RRC Resume failure” and “RRC Connection failure”. In that case, the state of RRC in the NCR 200A can be controlled while minimizing the impact of the specification. As the first information, there are three possibilities of “RRC Resume failure”, “RRC Connection failure”, and “Other”.

On the other hand, in the case of the NCR 200A in the RRC inactive, the frequency of occurrence of data addressed to the local terminal or data transmitted from the local terminal is significantly lower than that of the terminal 300. Furthermore, for example, in a case where data transmitted from the base station 100 to the terminal 300A is relayed, there is a possibility that the NCR-Fwd 200C fails to appropriately relay the data because the NCR 200A is in the RRC idle state. Therefore, when the NCR 200A is in the RRC idle state, other communication devices (for example, the base station 100 and the terminal 300A) are also affected.

As described above, it is not possible to perform the process of the NCR 200A in the case where the first state is RRC inactive, in the same manner as the terminal 300.

Therefore, the process in the NCR 200A in the RRC inactive state will be described below.

### First Example of First Process of NCR 200A in RRC Inactive State

In the first example of the first process of the NCR 200A in the RRC inactive state, in a case where the NCR 200A in the RRC inactive state transitions from the RRC inactive state to the RRC idle state, a notification of release cause is given from the RRC layer 222 to the NAS layer 221 as “RRC Resume failure” or “RRC Connection failure”. In short, the same information as that in any of the case where the transition from the RRC connected to the RRC idle is made or the case where the transition from the RRC inactive to the RRC connected is tried but is failed is notified as the second information.

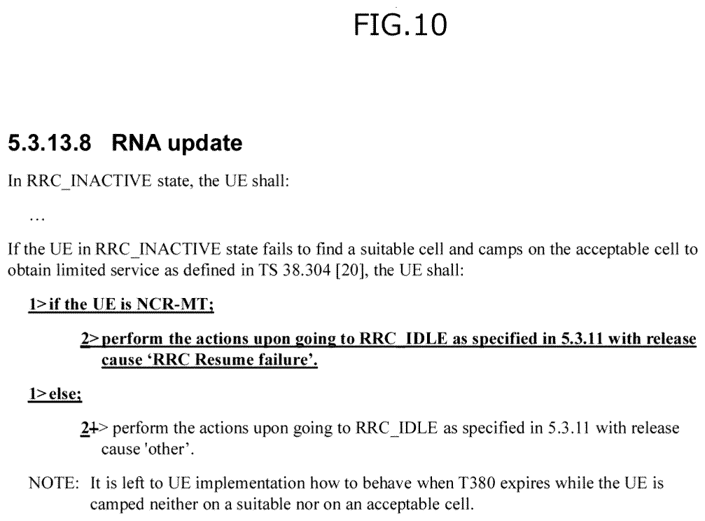

In this way, it is possible to reflect the information in the specification while suppressing the impact on the specification. An example thereof is illustrated in FIG. 10. FIG. 10 is a diagram illustrating an example in which the first example of the first process of the NCR 200A in the RRC inactive state according to the third embodiment is reflected in the specification (TS38.331). As illustrated in FIG. 10, in the case of the NCR-MT 200B, “RRC Resume failure” can be notified by the release cause.

### Second Example of First Process of NCR 200A in RRC Inactive State

In the second example of the first process of the NCR 200A in the RRC inactive state, in a case where the NCR 200A in the RRC inactive state transitions from the RRC inactive state to the RRC idle state, “Other” is set to notify release cause. Then, in the NAS layer 221 of the NCR 200A, the registration area update process is executed also in a case where the release cause is “Other”.

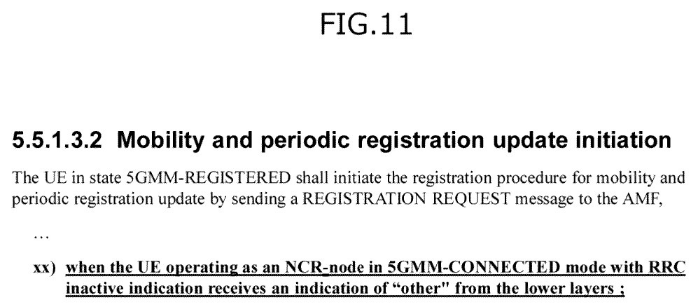

In this way, it is possible to reflect the information in the specification while suppressing the impact on the specification. An example is illustrated in FIG. 11. FIG. 11 is a diagram illustrating an example in which the second example of the first process of the NCR 200A in the RRC inactive state of the third embodiment is reflected in the specification (TS24.501). As illustrated in FIG. 11, reception of “Other” can be a trigger for the registration area update process.

### Third Example of First Process of NCR 200A in RRC Inactive State

In the third example of the first process of the NCR 200A in the RRC inactive state, in the NCR 200A in the RRC inactive state, a release cause in a case where the state transitions from the RRC inactive state to the RRC idle state is newly defined as “New Release Cause”. Then, it is set to a state in which it can be used for all communication devices having a relay function, and to a state in which it can be applied to other than the NCR 200A. Then, in the NAS layer 221 of the NCR 200A, the registration area update process is executed even when the release cause is “New Release Cause”. Note that “New Release Cause” is an example of a fourth cause, for example. Then, in the NAS layer 221 of the NCR 200A, the registration area update process is executed even when the release cause is “New Release Cause”.

### Fourth Example of First Process of NCR 200A in RRC Inactive State

In the fourth example of the first process of the NCR 200A in the RRC inactive state, when the NCR 200A in the RRC inactive state transitions to the RRC idle state, the registration area update process is executed regardless of the release cause. In this case, the notification of the release cause need not be made. Therefore, for example, in step S31 in FIG. 9, information indicating that the RRC state has transitioned to the second state is notified as the first information, and the process of step S33 is performed. In short, the process in step S32 is not executed.

As described above, by using at least one of the first example to the fourth example of the first process of the NCR 200A in the RRC inactive state, when the NCR 200A in the RRC inactive state transitions to the RRC idle state, the time until the transition to the RRC connected state can be shortened.

As described above, in the third embodiment, the NCR 200A (the relay device 200) that has transitioned from the RRC connected state or the RRC inactive state to the RRC idle state can start the first process for entering the RRC connected state at the transition timing. Therefore, when the state of the RRC of the relay device 200 transitions to the second state, the state of the RRC can be changed by executing the first process. In short, when the state of the RRC of the relay device 200 transitions to the second state, the first process can be executed. Therefore, the NCR 200A (relay device 200) can change the state of the RRC. In other words, it is possible to control the transition of the RRC state of the communication device such as the relay device 200. For example, since the NCR 200A (relay device 200) in the RRC idle state executes the first process for transitioning to a state different from the RRC idle state at the timing of transitioning to the idle state, when the base station 100 transmits a signal to the terminal 300, it is possible to reduce the probability that the RRC state of the relay device 200 is the idle state.

Note that, in the third embodiment, the NCR 200A has been described, but the third embodiment is not limited thereto, and may be applied to a communication device having a similar function. For example, when the terminal 300 has a relay function and relays communication between another terminal 300 and the base station 100, the transition of the RRC state may be controlled using the method of the third embodiment. In this case, the controller 320 of the terminal 300 having a relay function determines whether or not to perform the first process described as the process of the relay device 200 or the second process which is the process of the normal terminal 300 according to whether or not the local terminal relays another terminal 300. Note that the second process is, for example, a process different from the first process when transitioning from the RRC inactive state to the RRC idle state.

### Fourth Embodiment

In the first embodiment, an example has been described in which the first signal is transmitted in response to the transition of the relay device 200 to the second RRC state, and the state of the RRC transitions from the second state to the third state. In the second embodiment, a more specific method of the first embodiment has been described. In the third embodiment, a detailed example of the relationship between the first information and the second information in the second embodiment has been described. In the fourth embodiment, an example in which the state of the RRC is not transitioned from the first state to the second state will be described. In the fourth embodiment, the wireless communication system, the base station, the relay device, and the terminal are the same as those in the first to the third embodiments, and thus description thereof is omitted.

The controller 220 of the relay device 200 in the fourth embodiment performs control to select only a suitable cell in cell selection or reselection in the RRC inactive state. In short, in step S11 in FIG. 7, the process is performed such that NO is always selected. With this process, the state of the RRC does not transition to the second state due to cell selection or reselection in the RRC inactive state. Therefore, the relay device 200 can maintain the first state.

For example, in a case where the second state is RRC idle, the relay device 200 does not transition to RRC idle accompanying cell selection or reselection in the RRC inactive state.

As described above, in the fourth embodiment, in the relay device 200, control is performed such that only a suitable cell is selected in cell selection or reselection in the RRC inactive state. Therefore, the state of the RRC of the relay device 200 does not transition to the second state along with cell selection or reselection in the RRC inactive state. In other words, it is possible to control the transition of the RRC state of the communication device such as the relay device 200. For example, the RRC inactive relay device 200 does not transition from RRC inactive to RRC idle. Therefore, it is possible to transition from the RRC inactive state to the RRC connected state at a given timing. Therefore, when the base station 100 transmits data to the terminal 300, the probability that the RRC state of the relay device 200 is the idle state can be reduced.

In the fourth embodiment, the relay device 200 has been described, but the fourth embodiment is not limited thereto, and may be applied to a communication device having a similar function. For example, when the terminal 300 has a relay function and relays communication between another terminal 300 and the base station 100, the transition of the RRC state may be controlled using the method of the fourth embodiment. In this case, the controller 320 of the terminal 300 having a relay function determines whether or not to select a cell other than a suitable cell in the cell selection or the cell reselection in the RRC inactive state described as the process of the relay device 200 according to whether or not the local terminal relays another terminal 300.

### Hardware Configuration of Each Device in Each Embodiment

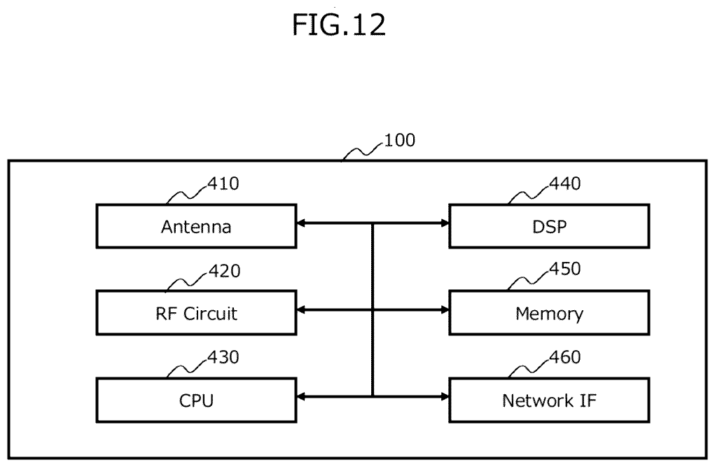

A hardware configuration of each device in the wireless communication system of each embodiment will be described with reference to FIGS. 12 to 14.

FIG. 12 is a diagram illustrating an example of a hardware configuration of the base station 100. As illustrated in FIG. 12, the base station 100 includes, for example, a radio frequency (RF) circuit 420 including an antenna 410, a central processing unit (CPU) 430, a digital signal processor (DSP) 440, a memory 450, and a network interface (IF) 460 as hardware components. The CPU is connected via a bus so as to be able to input and output various signals and data signals. The memory 450 includes, for example, at least one of a random access memory (RAM) such as a synchronous dynamic random access memory (SDRAM), a read only memory (ROM), and a flash memory, and stores a program, control information, and a data signal.

The correspondence between the functional configuration of the base station 100 illustrated in FIG. 2 and the hardware configuration of the base station 100 illustrated in FIG. 12 will be described. The transmitter 111 and the receiver 112 (or the wireless communication unit 110) are realized by, for example, the RF circuit 420, or the antenna 410 and the RF circuit 420. The controller 120 is realized by, for example, the CPU 430, the DSP 440, the memory 450, a digital electronic circuit (not illustrated), and the like. Examples of the digital electronic circuit include an application specific integrated circuit (ASIC), a field programmable gate array (FPGA), and a large scale integration (LSI). Furthermore, the storage unit 130 is realized by, for example, the memory 450. Furthermore, the communication unit 140 is implemented by, for example, the network IF 460.

Note that, in the base station 100, a plurality of data signals transmitted in a plurality of sub-bands can be generated, but a filter for generating the data signals may be configured independently for each sub-band.

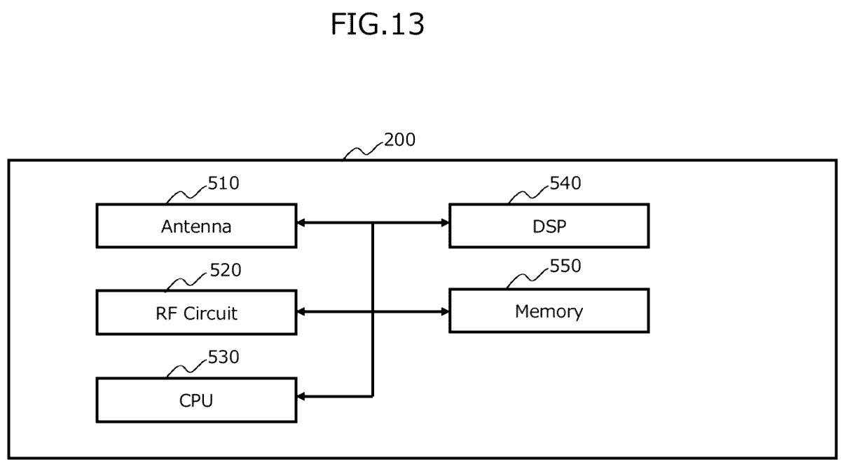

FIG. 13 is a diagram illustrating an example of a hardware configuration of the relay device 200. As illustrated in FIG. 13, the relay device 200 includes, for example, an RF circuit 520 including an antenna 510, a CPU 530, a DSP 540, and a memory 550 as hardware components. The memory 550 includes, for example, at least one of a RAM such as an SDRAM, a ROM, and a flash memory, and stores a program, control information, and a data signal.

The correspondence between the functional configuration of the relay device 200 illustrated in FIG. 3 and the hardware configuration of the relay device 200 illustrated in FIG. 13 will be described. The transmitter 211 and the receiver 212 (or the communication unit 210) are realized by, for example, the RF circuit 520, or the antenna 510 and the RF circuit 520. The controller 220 is realized by, for example, the CPU 530, the DSP 540, the memory 550, a digital electronic circuit (not illustrated), and the like. Examples of the digital electronic circuit include an ASIC, an FPGA, and an LSI. Furthermore, the storage unit 230 is realized by, for example, the memory 550.

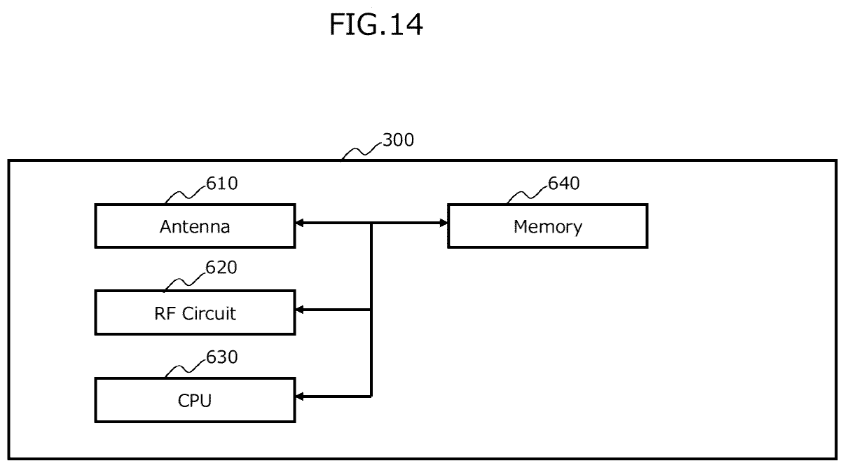

FIG. 14 is a diagram illustrating an example of a hardware configuration of the terminal 300. As illustrated in FIG. 14, the terminal 300 includes, for example, an RF circuit 620 including an antenna 610, a CPU 630, and a memory 640 as hardware components. Furthermore, the terminal 300 may include a display device such as a liquid crystal display (LCD) connected to the CPU 630. The memory 640 includes, for example, at least one of a RAM such as an SDRAM, a ROM, and a flash memory, and stores a program, control information, and a data signal.

The correspondence between the functional configuration of the terminal 300 illustrated in FIG. 4 and the hardware configuration of the terminal 300 illustrated in FIG. 14 will be described. The transmitter 311 and the receiver 312 (or the communication unit 310) are realized by, for example, the RF circuit 620, or the antenna 610 and the RF circuit 620. The controller 320 is realized by, for example, the CPU 630, the memory 640, a digital electronic circuit (not illustrated), and the like. Examples of the digital electronic circuit include an ASIC, an FPGA, and an LSI. Furthermore, the storage unit 330 is realized by, for example, the memory 640.

Note that the embodiments may be appropriately combined within a range without inconsistency.

Note that, in each embodiment, an example of the base station, the terminal, and the relay device has been described, but the disclosed technology is not limited thereto, and can be applied to various devices such as electronic devices mounted on automobiles, trains, airplanes, artificial satellites, and the like, electronic devices carried by drones and the like, robots, AV devices, household appliances, office devices, vending machines, and other household appliances.

In each embodiment, the fifth generation mobile communication has been described as an example. However, the disclosed technology is not limited to these. For example, the disclosed technology may be applied to mobile communication of different generations such as a sixth generation and a seventh generation.

According to the embodiments, it is possible to provide a relay device, a base station, a wireless communication system, and the like that control the transition of the RRC state of the communication device such as the NC repeater.

Throughout the descriptions, the indefinite article “a” or “an”, or adjective “one” does not exclude a plurality.

All examples and conditional language recited herein are intended for the pedagogical purposes of aiding the reader in understanding the disclosure and the concepts contributed by the inventor to further the art, and are not to be construed limitations to such specifically recited examples and conditions, nor does the organization of such examples in the specification relate to a showing of the superiority and inferiority of the disclosure. Although one or more embodiments of the present disclosures have been described in detail, it should be understood that the various changes, substitutions, and alterations could be made hereto without departing from the spirit and scope of the disclosure.

What is claimed is:

1. A relay device comprising:
a controller configured to execute a first process when a state of RRC transitions from a first state to a second state;
a transmitter configured to transmit a first signal for transitioning the state of the RRC from the second state to a third state according to the first process; and
a receiver configured to receive a transmitted second signal in response to the first signal,
wherein the controller transitions the state of the RRC from the second state to the third state according to the second signal.

2. The relay device according to claim 1, wherein
the transmitter transmits a third signal when the transition to the third state is completed.

3. The relay device according to claim 1, wherein
the first state is an RRC inactive state, and
the second state is an RRC idle state, and
the third state is RRC connected state.

4. The relay device according to claim 3, wherein
the first process includes a process of notifying first information from an RRC layer to a NAS layer and a process of determining whether or not the first information corresponds to second information by the NAS layer, and
the first process includes, when the first information corresponds to the second information, a process of triggering a second process, and the second process includes a process of controlling to transmit a fourth signal that is a signal of the NAS layer from the transmitter.

5. The relay device according to claim 4, wherein
the first information is information corresponding to a cause of transition to the second state among a plurality of pieces of information that are causes of transition of the state of the RRC to the second state, and
the second information corresponds to at least one of the plurality of pieces of information.

6. The relay device according to claim 5, wherein
each of the plurality of pieces of information corresponds to a respective one of a plurality of release causes, and the plurality of release causes include at least a first cause, a second cause, and a third cause,
the second information corresponds to the first cause and the second cause,
the first process includes a process of notifying, when transition is made from the first state to the second state, the NAS layer of the first cause or the second cause as the first information from the RRC layer, and
the third cause is, when a state of RRC of a terminal transitions from the RRC inactive state to the RRC idle state in the terminal, a cause notified from the RRC layer of the terminal to the NAS layer.

7. The relay device according to claim 5, wherein
each of the plurality of pieces of information corresponds to a respective one of a plurality of release causes, and the plurality of release causes include at least a first cause, a second cause, and a third cause,
the second information corresponds to the first cause, the second cause, and the third cause,
the first process includes a process of notifying, when transition is made from the first state to the second state, the NAS layer of the third cause as the first information from the RRC layer, and
the third cause is, when a state of RRC of a terminal transitions from the RRC inactive state to the RRC idle state in the terminal, a cause notified from the RRC layer of the terminal to the NAS layer.

8. The relay device according to claim 5, wherein each of the plurality of pieces of information corresponds to respective one of a plurality of release causes, and the plurality of release causes includes at least a first cause, a second cause, a third cause, and a fourth cause,
the second information corresponds to the first cause, the second cause, and the fourth cause,
the first process includes a process of notifying, when transition is made from the first state to the second state, the NAS layer of the fourth cause as first information from the RRC layer,
the first cause, the second cause, and the third cause are similar to a cause transmitted when a state of RRC of a terminal transitions to an idle state in the terminal, and
the fourth cause is a cause used when the relay device transitions from the first state to the second state in the terminal, and is different from the first cause, the second cause, and the third cause.

9. The relay device according to claim 1, wherein
the first process includes a process of notifying a NAS layer from an RRC layer of transition information indicating that transition is made to the second state, and
the NAS layer includes a process of controlling to trigger a second process including a process of transmitting a fourth signal that is a signal of the NAS layer according to the transition information.

10. A base station comprising:
a receiver configured to receive, when a state of RRC of a relay device transitions from a first state to a second state, a first signal for transitioning the state of the RRC from the second state to a third state, the first signal being transmitted from the relay device according to a first process executed by the relay device; and
a transmitter configured to transmit a second signal for causing the state of the RRC of the relay device to transition from the second state to the third state according to the first signal.

11. A wireless communication system including a relay device that relays a signal transmitted from a base station to a terminal,
wherein the relay device comprises:
a controller configured to execute a first process when a state of RRC transitions from a first state to a second state; and
a first transmitter configured to transmit a first signal for transitioning the state of the RRC from the second state to a third state according to the first process, and
wherein the base station includes:
a receiver configured to receive the first signal; and
a second transmitter configured to transmit a second signal for causing the state of the RRC of the relay device to transition from the second state to the third state according to the first signal.
